(19) United States
(12) Patent Application Publication
(10) Pub. No.: US 2016/0200383 A1
(43) Pub. Date: Jul. 14, 2016

(54) LIGHTING DEVICE FOR A BICYCLE

(71) Applicant: William Philip MCALEESE, Newtownards County Down (GB)

(72) Inventor: William Philip McAleese, Newtownards, County Down (GB)

(21) Appl. No.: 14/913,590

(22) PCT Filed: Aug. 14, 2014
(86) PCT No.: PCT/EP2014/067416

§ 371 Date: Feb. 22, 2016

(30) Foreign Application Priority Data
Aug. 21, 2013 (GB) 1314944.8

(51) Int. Cl. B62J 6/00; B62J 11/00

(52) U.S. Cl. CPC B62J 6/001; B62J 11/00; B62J 6/003

(57) ABSTRACT

A lighting device for a bicycle comprising at least one light emitter and a controller programmed to vary the brightness and/or flash rate and/or flashing pattern of the at least one light emitter based upon the measurement of the motion of the device. The controller may be provided with sensor means to measure one or more of the acceleration, orientation and rate of change of orientation of the device, wherein the controller compares the measured acceleration, orientation and/or rate of change of orientation with reference data contained in predetermined look-up tables to determine a risk score, the controller selecting the brightness and/or flash rate and/or flashing pattern of the at least one light emitter as a function of the risk score.

### CROSS REFERENCE TO RELATED APPLICATIONS

The present application is a §371 national stage of International Application PCT/EP2014/067416, filed Aug. 14, 2014, which claims the priority benefit of U.K. patent application Ser. No. 1314944.8, filed Aug. 21, 2013, both of which are herein incorporated by reference in their entireties.

### FIELD OF THE INVENTION

This invention relates to a lighting device and in particular to a lighting device for a bicycle for alerting other road users of the presence of the bicycle, particularly during high risk manoeuvres, such as when braking or changing direction.

### BACKGROUND OF THE INVENTION

Bicycle users are one of the most vulnerable groups of road users. Furthermore, the small size of a bicycle compared to other vehicles, particularly from the front or rear of the bicycle, makes it harder for other road users to see bicycles.

Bicycle lighting systems are known for improving the visibility of bicycles, particularly in low light conditions. Such typically comprise light units mounted on the front and rear of the bicycle, each unit having an incandescent bulb, or more commonly an array of LEDs, typically with white LEDs at the front and red LEDs at the rear. Such light units typically contain one or more batteries for powering the respective LEDs to provide continuous illumination. It is also known to provide control circuitry arranged to cause the LEDs to flash at a predetermined rate. Flashing LEDs are often preferred as such may be more effective at attracting the attention of other road users and may also prolong battery life when compared to light units with continuous illumination.

Accident statistics from around the world indicate that more than two thirds of cycle accidents occur in urban areas, at or near road junctions and in daylight hours. Most bicycle lights are insufficiently bright to be visible in these situations. Moreover, current bicycle light designs frequently focus their beam pattern to a tight rearward cone. This limits their side visibility, compromising their effectiveness.

Another problem with such known bicycle lighting systems is that they do not provide any variation in illumination and thus do not provide a feedback to the viewer to indicate that the bicycle may be decelerating or changing direction.

An object of the present invention is to provide an improved bicycle lighting device that provides greater visibility for cyclists during higher risk scenarios.

### SUMMARY OF THE INVENTION

According to an aspect of the present invention there is provided a lighting device for a bicycle comprising at least one light emitter and a controller programmed to vary the brightness and/or flash rate and/or flashing pattern of the at least one light emitter based upon the measurement of the motion of the device.

In one embodiment the at least one light emitter comprises one or more light emitting diodes (LEDs).

The controller may be provided with a sensor or sensor means to measure one or more of the acceleration, orientation and rate of change of orientation of the device. Preferably the sensor means comprises a three axis accelerometer.

Optionally, the controller compares the measured acceleration, orientation and/or rate of change of orientation with reference data contained in predetermined look-up tables to determine a risk score, the controller selecting the brightness and/or flash rate and/or flashing pattern of the at least one light emitter as a function of the risk score.

The controller effectively assesses the magnitude of a risk situation and activates the at least one light emitter in reaction to this. The system may also incorporate a microphone and/or other sensors, such as a light sensor, providing at least one further input signal to the controller.

In one embodiment, the device may incorporate different coloured LEDs, different LEDs being illuminated depending upon the orientation of the device, such that the device may be used as both a front light and a back light depending upon its orientation (i.e. white LEDs being illuminated in one orientation by use as a front light and red LEDs being illuminated in another orientation for use as a rear light).

These and other objects, advantages and features of the invention will become apparent upon review of the following specification in conjunction with the drawings.

### BRIEF DESCRIPTION OF THE DRAWINGS

A bicycle lighting device in accordance with an embodiment of the present invention will now be described, by way of example only, with reference to the accompanying drawings, in which:

FIG. 1 is a perspective view of a portable lighting device in accordance with an embodiment of the present invention;

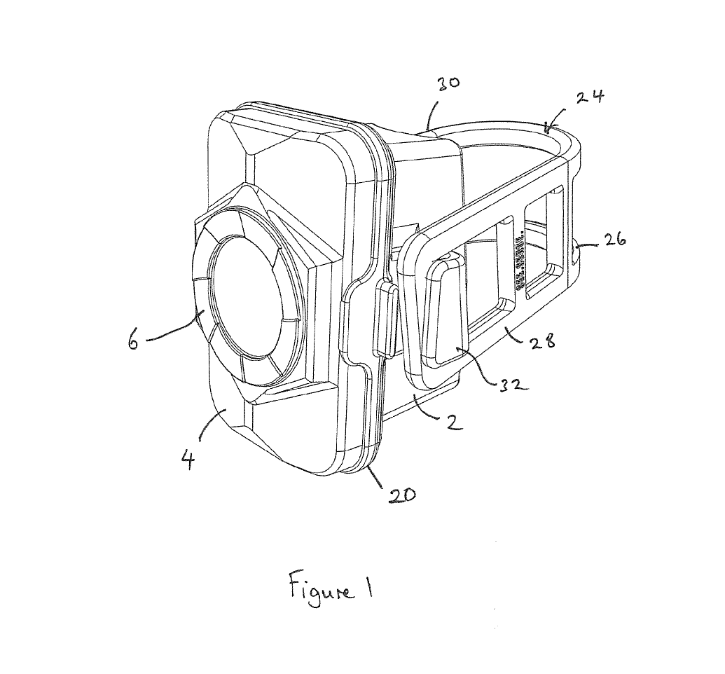

FIG. 2 is a perspective view of the device of FIG. 1 from the rear;

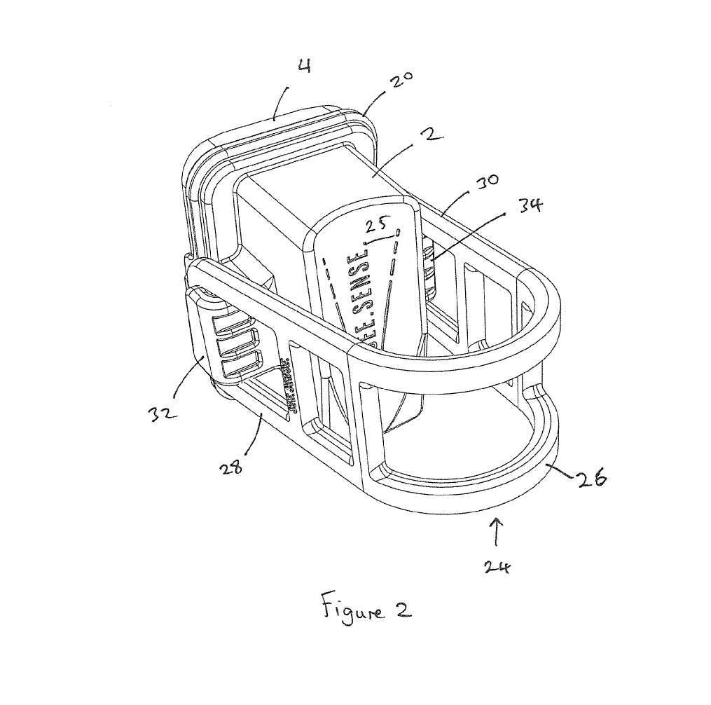

FIG. 3 front view of the device of FIG. 1;

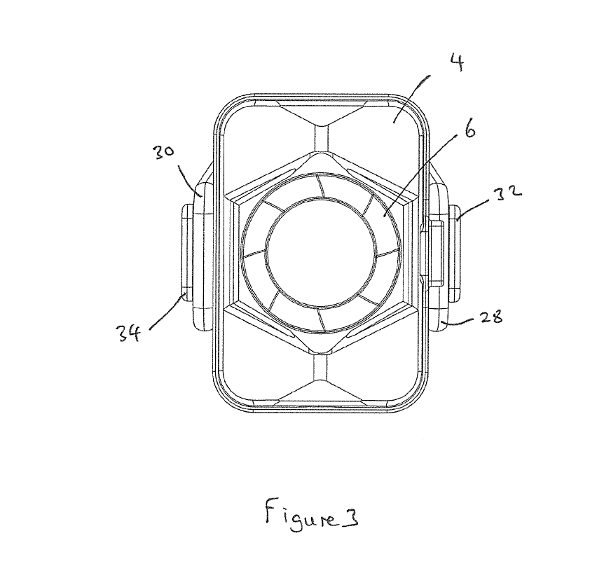

FIG. 4 is a rear view of the device of FIG. 1;

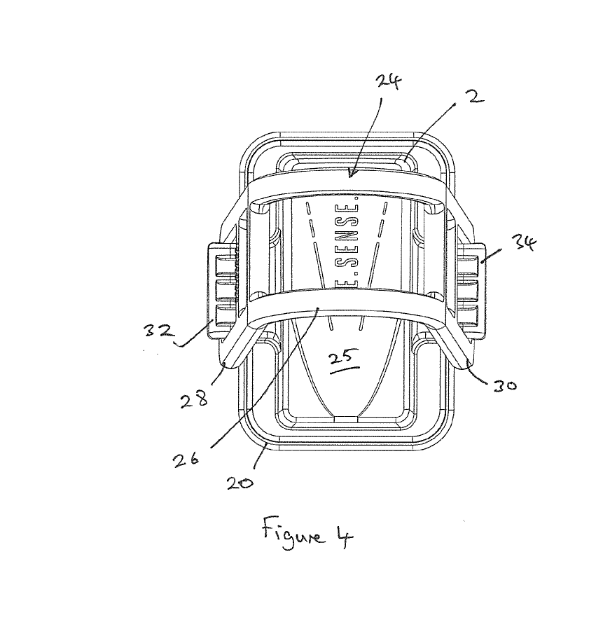

FIG. 5 is a top view of the device of FIG. 1;

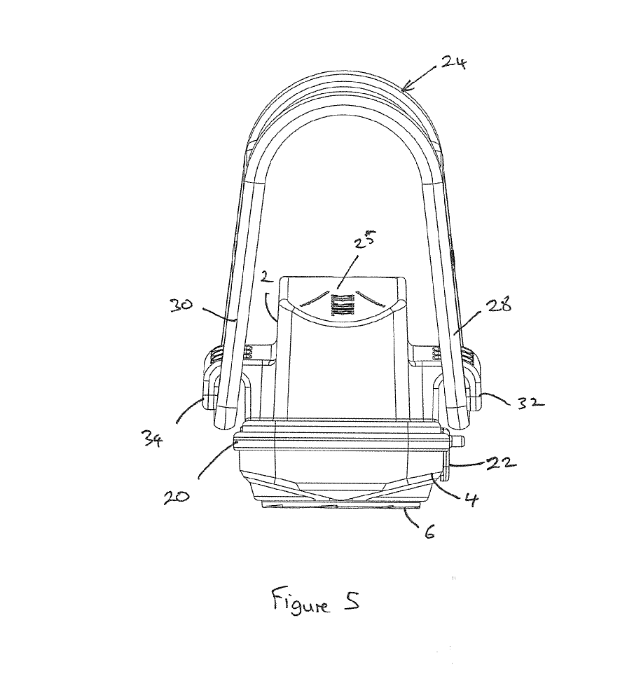

FIG. 6 is an exploded perspective view of the device of FIG. 1; and

FIG. 7 is an exploded perspective view of the device of FIG. 1 from the rear.

### DETAILED DESCRIPTION OF THE PREFERRED EMBODIMENTS

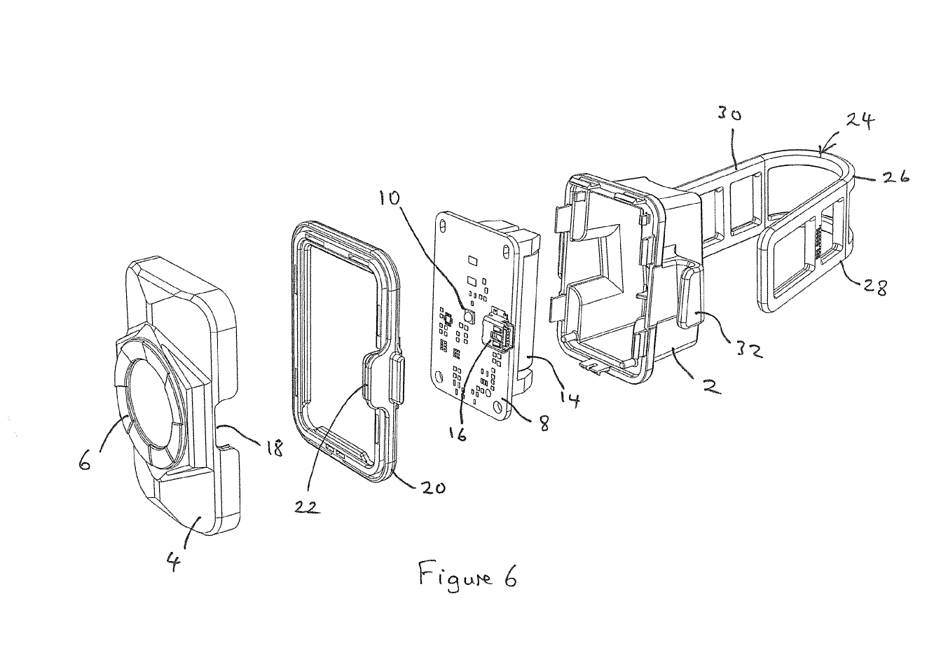

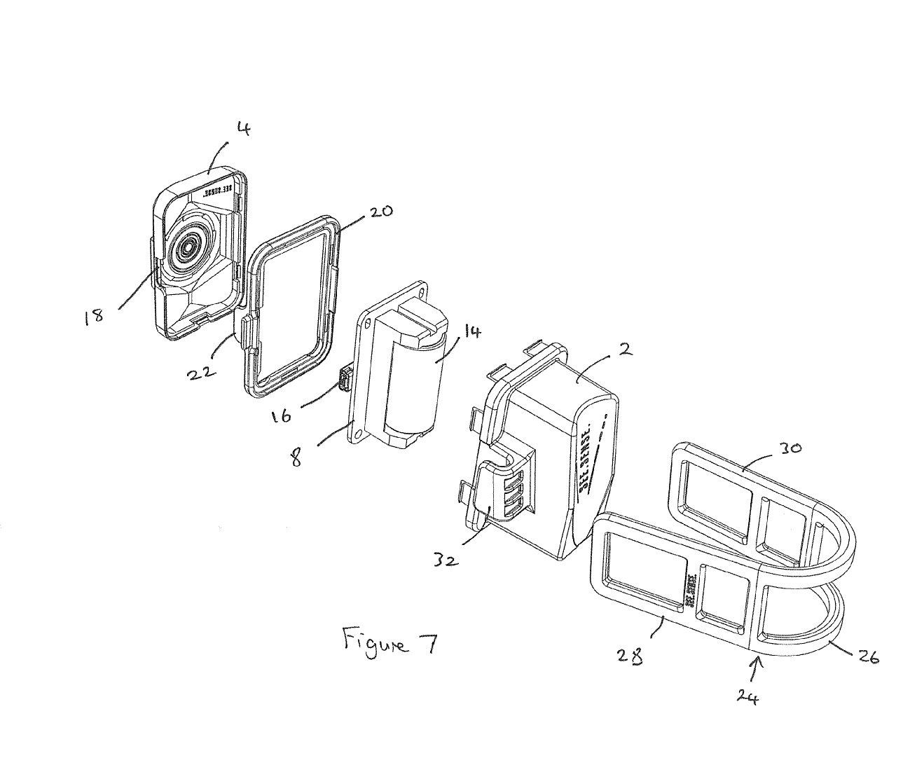

As shown in the drawings, with particular reference to FIGS. 6 and 7, a portable lighting device in accordance with an embodiment of the present invention, particularly a lighting device intended for attachment to a bicycle, comprising a housing 2 having a front cover 4 incorporating a Fresnel lens 6, a printed circuit board 8 being mounted within the housing 2, the printed circuit board 8 incorporating a high intensity LED 10 arranged to pass light through the Fresnel lens 6 of the front cover. The printed circuit board 8 also incorporates LED drive circuitry, a programmable microcontroller for controlling operation of the LED 10 as well as a three axis accelerometer connected to the microcontroller.

A battery 14 is mounted on a rear side of the printed circuit board 8 for powering the device. The battery 14 may comprise a rechargeable battery.

A female USB connector 16 is provided on the printed circuit board 8 in a position to be aligned with an aperture 18 in the housing 2 and/or front cover 4 for charging the battery 14 and/or programming the microcontroller.

A silicone gasket 20 is provided between the housing 2 and the front cover 4 to provide a water resistant seal. The gasket incorporates a plug or bung 22 for sealing the USB connector 16.

A rear side of the housing 2 is shaped to engage a tubular portion of a bicycle frame. An elastic strap 24 is provided for mounting the device onto a bicycle, or other object. The elastic strap 24, which may be formed from silicone rubber or any other suitable elastomeric material, having a base portion 26 adapted to engage a rear side of a tubular frame or other object against which the device is mounted and a pair of wing portions 28, 30 extending from either side of the base portion adapted to be received over mounting flanges 32, 34 provided on the sides of the housing 2.

A rear face 25 of the housing 2 and the mounting flanges 32, 34 may be angled, for example at an angle of 10° to the front cover 4, to facilitate mounting of the device on an angled frame tube of a bicycle while ensuring that the front cover 4 of the device remains vertical so that light is emitted from the LED horizontally, via the focusing effect of the Fresnel lens 6.

Tabs (not shown) may be provided on each wing portion 28, 30 of the elastic strap 24 to enable the wing portions 28, 30 to be pulled over the mounting flanges 32, 34 of the housing 2.

The microcontroller is programmed to operate the LED as a function of data received from the accelerometer. The microcontroller utilises the accelerometer to measure the acceleration, orientation and rate of change of orientation of the device (i.e. roll, pitch and yaw) in 3 axes. This data is used to determine a “risk score”, indicative of the scenario in which the object (e.g. bicycle) is operating and the likely risk to the operator.

The measured values from the accelerometer may be compared to a look up table to detect the likely scenario in which the object is operating to determine the risk score or to further adjust the risk score.

Where the device is intended for use by a cyclist, stored data may be provided relating to known scenarios such as traversing a roundabout, filtering in traffic, approaching or exiting a road junction, sudden braking or swerving, sudden tyre puncture event, change of road surface (e.g. indicating an enhanced grip braking or cornering zone), asymmetric sideways movement (indicating a gust of wind or suction from a passing vehicle), sudden changes in rate or orientation, followed by a free-fall or spikes in acceleration, followed by a near rest state (indicating a potential collision or crash), and cadence (rate of pedalling) beyond the normal expected range.

The microcontroller may be programmed to adjust the brightness and/or rate or pattern of flashing of the LED based upon the determined risk score.

The intermittent operation of the LED, and reduced brightness operation during periods of low risk score, reduces the power consumption of the device compared to known bicycle lighting devices, while providing greater visibility during higher risk situations.

It is envisioned that devices in accordance with the present invention can be brighter than existing designs and can be implemented so that no beam focusing is required.

Further sensors may be provided on the device providing additional inputs to the microcontroller, the additional inputs being compared to reference data, along with data from the accelerometer, to determine the risk score. Such further sensors may comprise a microphone for detecting the noise levels adjacent the unit, which may indicate when the rider is in heavy traffic, and/or a light sensor, which may detect sudden in light level, indicating if it is day or night. Sudden changes in light level may indicate entering a tunnel or travelling under and overpass or may indicate the headlights of other vehicles illuminating the device. This data may be stored against time to give the device a prediction of ongoing ambient levels in order to let the device know if it is day or night, or more importantly, if the device is in an environment transitioning between night and day (at dawn or dusk) which is when many accidents occur. During these transition times, the device may apply a higher weighting to risk scores in order to increase flash rate/illumination to further increase the visibility of the user.

The invention is not limited to the embodiment(s) described herein but can be amended or modified without departing from the scope of the present invention, which is intended to be limited only by the scope of the appended claims as interpreted according to the principles of patent law including the doctrine of equivalents.

1. A lighting device for a bicycle, the lighting device comprising at least one light emitter and a controller programmed to vary the brightness and/or flash rate and/or flashing pattern of the at least one light emitter based upon a measurement of the motion of the device.

2. A device as claimed in claim 1, wherein the at least one light emitter comprises one or more light emitting diodes (LEDs).

3. A device as claimed in claim 1, wherein the controller is provided with a sensor operable to measure one or more of the acceleration, orientation and rate of change of orientation of the device.

4. A device as claimed in claim 3, wherein the sensor comprises a three axis accelerometer.

5. A device as claimed in claim 3, wherein the controller compares the measured acceleration, orientation and/or rate of change of orientation with reference data contained in predetermined look-up tables to determine a risk score, the controller selecting the brightness and/or flash rate and/or flashing pattern of the at least one light emitter as a function of the risk score.

6. A device as claimed claim 1, further comprising a microphone and/or further sensor, wherein the microphone and/or further sensor is operable to provide at least one further input signal to the controller.

7. A device as claimed in claim 6, wherein the further sensor comprises a light sensor.

8. A device as claimed in claim 1, wherein the at least one light emitter comprises different coloured LEDs, wherein different ones of the coloured LEDs are selectively illuminated depending upon the orientation of the device, such that the device may be used as both a front light and a back light of a vehicle depending upon its orientation.

9. A lighting device as claimed in claim 1, wherein the device includes a Fresnel lens through which light from the at least one light emitter is passed.

10. A lighting device as claimed in claim 1, wherein the device comprising a housing within which the at least one light emitter is mounted, the housing being provided with an elasticated strap for securing the housing to an object.

11. (canceled)
